(19) United States
(12) Patent Application Publication
(10) Pub. No.: US 2024/0304181 A1
(43) Pub. Date: Sep. 12, 2024

(54) CONNECTING DIFFERENT ASR APPLICATION DOMAINS WITH SPEAKER-TAGS

(71) Applicant: Google LLC, Mountain View, CA (US)

(72) Inventors: Guru Prakash Arumugam, Sunnyvale, CA (US); Shuo-yiin Chang, Sunnyvale, CA (US); Shaan Jagdeep Patrick Bijwadia, San Francisco, CA (US); Weiran Wang, San Jose, CA (US); Quan Wang, Hoboken, NJ (US); Rohit Prakash Prabhavalkar, Palo Alto, CA (US); Tara N. Sainath, Jersey City, NJ (US)

(73) Assignee: Google LLC, Mountain View, CA (US)

(21) Appl. No.: 18/598,523

(22) Filed: Mar. 7, 2024

Related U.S. Application Data
(60) Provisional application No. 63/489,170, filed on Mar. 8, 2023.

(51) Int. Cl. G10L 15/06

(52) U.S. Cl. CPC G10L 15/063

(57) ABSTRACT

A method includes receiving a plurality of training samples spanning multiple different domains. Each corresponding training sample includes audio data characterizing an utterance paired with a corresponding transcription of the utterance. The method also includes re-labeling each corresponding training sample of the plurality of training samples by annotating the corresponding transcription of the utterance with one or more speaker tags. Each speaker tag indicates a respective segment of the transcription for speech that was spoken by a particular type of speaker. The method also includes training a multi-domain speech recognition model on the re-labeled training samples to teach the multi-domain speech recognition model to learn to share parameters for recognizing speech across each of the different multiple different domains.

### CROSS REFERENCE TO RELATED APPLICATIONS

This U.S. Patent Application claims priority under 35 U.S.C. § 119(e) to U.S. Provisional Application No. 63/489,170, filed on Mar. 8, 2023. The disclosure of this prior application is considered part of the disclosure of this application and is hereby incorporated by reference in its entirety.

### TECHNICAL FIELD

This disclosure relates to connecting different ASR application domains with speaker tags.

### BACKGROUND

Automatic speech recognition (ASR) models transcribe speech inputs into corresponding text outputs. However, ASR models often suffer from a long-form deletion problem where the model predicts sequential blanks instead of words when transcribing long-form speech inputs. As a consequence of the long-form deletion problem, users may perceive the ASR model as being stuck (e.g., the ASR model intermittently emitting words) or the missing words induce cascading errors for downstream systems that receive the transcriptions output by the ASR model. One significant factor that causes the long-form deletion problem is a training dataset and test dataset mismatch. That is, the domain of the training dataset that trains the ASR model does not match the domain of the test dataset the ASR model receives during inference.

### SUMMARY

One aspect of the disclosure provides a computer-implemented method executed on data processing hardware that causes the data processing hardware to perform operations for connecting different ASR application domains with speaker tags. The operations include receiving a plurality of training samples spanning multiple different domains. Each corresponding training sample includes audio data characterizing an utterance that is paired with a corresponding transcription of the utterance. The operations further include re-labeling each corresponding training sample of the plurality of training samples by annotating the corresponding transcription of the utterance with one or more speaker tags. Each speaker tag indicates a respective segment of the transcription for speech that was spoken by a particular type of speaker. The operations also include training a multi-domain speech recognition model on the re-labeled training samples to teach the multi-domain speech recognition model to learn to share parameters for recognizing speech across each of the multiple different domains.

Implementations of the disclosure may include one or more of the following optional features. In some implementations, the multiple different domains include a short-form query domain and a dictation domain. In these implementations, the multiple different domains further include a captions domain. In some examples, the corresponding transcription for each training sample includes at least one of a whole transcript of all speech present in the corresponding audio data or a primary transcript of only speech spoken by a primary speaker in the corresponding audio data. In these examples, re-labeling each corresponding training sample of the plurality of training samples includes performing a sub-sequence match between the whole transcript and the primary transcript to identify one or more speaker tag boundaries and annotating the whole transcript with the one or more speaker tags based on the one or more speaker tag boundaries identified by performing the sub-sequence match between the whole transcript and the primary transcript.

The particular type of speaker indicated by each speaker tag may include a primary speaker or a non-primary speaker. Here, speech spoken by the primary speaker corresponds to speech directed toward a target application and speech spoken by the non-primary speaker includes at least one of background speech spoken by a speaker other than the primary speaker, recorded or broadcasted speech emanating from an audio output device, or synthesized speech. In some implementations, for each training sample of the plurality of training samples having a corresponding transcription that includes only a primary transcript of speech spoken by a primary speaker in the corresponding audio data and omits transcripts of any other speech in the corresponding audio data not spoken by the primary speaker, the operations further include processing the corresponding audio data to obtain a whole transcript of all speech present in the corresponding audio data using a general teacher speech recognition model. Here, re-labeling the corresponding training sample incudes re-labeling the corresponding training sample based on the primary transcript and the whole transcript. In these implementations, the general teacher speech recognition model is trained on a training data set to teach the teacher speech recognition model to recognize primary speech, secondary speech, and background noise speech.

In some examples, for each training sample of the plurality of training samples having a corresponding transcription that includes only a whole transcript of all speech present in the corresponding audio data, the operations further include processing the corresponding audio data to obtain a primary transcript of only speech spoken by a primary speaker in the corresponding audio data using a primary teacher speech recognition model. Here, re-labeling the corresponding training sample includes re-labeling the corresponding training sample based on the primary transcript and the whole transcript. In these examples, the primary teacher speech recognition model is trained on supervised data obtained from domains that require only a primary speaker transcript.

Another aspect of the disclosure provides a system that includes data processing hardware and memory hardware storing instructions that when executed on the data processing hardware causes the data processing hardware to perform operations. The operations include receiving a plurality of training samples spanning multiple different domains. Each corresponding training sample includes audio data characterizing an utterance that is paired with a corresponding transcription of the utterance. The operations further include re-labeling each corresponding training sample of the plurality of training samples by annotating the corresponding transcription of the utterance with one or more speaker tags. Each speaker tag indicates a respective segment of the transcription for speech that was spoken by a particular type of speaker. The operations also include training a multi-domain speech recognition model on the re-labeled training samples to teach the multi-domain speech recognition model to learn to share parameters for recognizing speech across each of the multiple different domains.

Implementations of the disclosure may include one or more of the following optional features. In some implementations, the multiple different domains include a short-form query domain and a dictation domain. In these implementations, the multiple different domains further include a captions domain. In some examples, the corresponding transcription for each training sample includes at least one of a whole transcript of all speech present in the corresponding audio data or a primary transcript of only speech spoken by a primary speaker in the corresponding audio data. In these examples, re-labeling each corresponding training sample of the plurality of training samples includes performing a sub-sequence match between the whole transcript and the primary transcript to identify one or more speaker tag boundaries and annotating the whole transcript with the one or more speaker tags based on the one or more speaker tag boundaries identified by performing the sub-sequence match between the whole transcript and the primary transcript.

The particular type of speaker indicated by each speaker tag may include a primary speaker or a non-primary speaker. Here, speech spoken by the primary speaker corresponds to speech directed toward a target application and speech spoken by the non-primary speaker includes at least one of background speech spoken by a speaker other than the primary speaker, recorded or broadcasted speech emanating from an audio output device, or synthesized speech. In some implementations, for each training sample of the plurality of training samples having a corresponding transcription that includes only a primary transcript of speech spoken by a primary speaker in the corresponding audio data and omits transcripts of any other speech in the corresponding audio data not spoken by the primary speaker, the operations further include processing the corresponding audio data to obtain a whole transcript of all speech present in the corresponding audio data using a general teacher speech recognition model. Here, re-labeling the corresponding training sample incudes re-labeling the corresponding training sample based on the primary transcript and the whole transcript. In these implementations, the general teacher speech recognition model is trained on a training data set to teach the teacher speech recognition model to recognize primary speech, secondary speech, and background noise speech.

In some examples, for each training sample of the plurality of training samples having a corresponding transcription that includes only a whole transcript of all speech present in the corresponding audio data, the operations further include processing the corresponding audio data to obtain a primary transcript of only speech spoken by a primary speaker in the corresponding audio data using a primary teacher speech recognition model. Here, re-labeling the corresponding training sample includes re-labeling the corresponding training sample based on the primary transcript and the whole transcript. In these examples, the primary teacher speech recognition model is trained on supervised data obtained from domains that require only a primary speaker transcript.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example speech recognition model.

FIGS. 3A and 3B are schematic views of an example training data re-labeling process.

FIG. 4 is a schematic view of an example training process for training the speech recognition model.

FIG. 5 is a schematic view of an example sub-sequencing matching process.

FIG. 6 is a flowchart of an example arrangement of operations for a computer-implemented method of connecting different automatic speech recognition application domains with speaker tags.

FIG. 7 is a schematic view of an example computing device that may be used to implement the systems and methods described herein.

Like reference symbols in the various drawings indicate like elements.

### DETAILED DESCRIPTION

Automatic speech recognition (ASR) models are capable of transcribing speech from several different scenarios. For example, ASR models are capable of transcribing: clean audio and noisy audio that includes background speech or music; short-form queries directed towards a virtual assistant; and/or captioning long-form speech such as videos, podcasts, audiobooks, etc. As such, ASR models are trained with data from various different sources and noise conditions to ensure robust performance of the ASR models during inference. Yet, one problem for ASR models is a long-form deletion problem that causes the ASR models to produce high deletion errors for long-form audio inputs. For instance, a virtual assistant application aims to transcribe speech for only a primary speaker that speaks towards the virtual assistant and ignore all other speech. In contrast, a dictation application aims to transcribe all speech spoken by multiple speakers such as transcribing a video meeting with multiple participants. As such, training an ASR model on one domain and not the other will cause the long-form deletion problem during inference.

As a consequence of the long-form deletion problem, users may perceive the ASR model as being stuck (e.g., the ASR model intermittently emitting words) or the missing words induce cascading errors for downstream systems that receive the transcriptions output by the ASR model. For example, an ASR model trained on short-form queries may suffer from the long-form deletion problem when the ASR model receives long-form queries (e.g., hours long videos for captioning) during inference, and vice versa. Moreover, training ASR models using training data that combines multiple different domains (e.g., a domain where only speech from a primary speaker is transcribed and another domain where all speech is transcribed) may cause confusion and/or the long-form deletion problem for the ASR model. Namely, the ASR model will struggle to determine whether to transcribe speech from the primary speaker that directs speech toward a target application, other speakers that are not necessarily speaking towards the target application (e.g., background speech/noise), or some combination thereof.

Accordingly, implementations herein are directed towards methods and systems for connecting different ASR application domains with speaker tags. In particular, the method includes receiving a plurality of training samples spanning multiple different domains. The multiple different domains may include a short-form query domain and a dictation domain whereby speech from a primary speaker is directed towards a target application (e.g., virtual/voice assistant, search engine, or dictation assistant). The multiple different domains may also include a captions domain whereby speech from multiple speakers is directed towards the target application (e.g., captioning assistant). As such, the ASR model aims to transcribe only speech spoken by the primary speaker for the short-form query domain and the dictation domain while the ASR model aims to transcribe all speech spoken by each speaker for the captions domain. Each corresponding training sample includes audio data characterizing an utterance and is paired with a corresponding transcription of the utterance. The method also includes re-labeling each corresponding training sample by annotating the corresponding transcription of the utterance with one or more speaker tags and training a multi-domain speech recognition model on the re-labeled training samples to teach the multi-domain speech recognition model to learn to share parameters for recognizing speech across each of the multiple different domains. Notably, the method trains the multi-domain speech recognition model without using a domain identifier, but rather re-labels the plurality of training samples and trains the multi-domain speech recognition model on the re-labeled plurality of training samples.

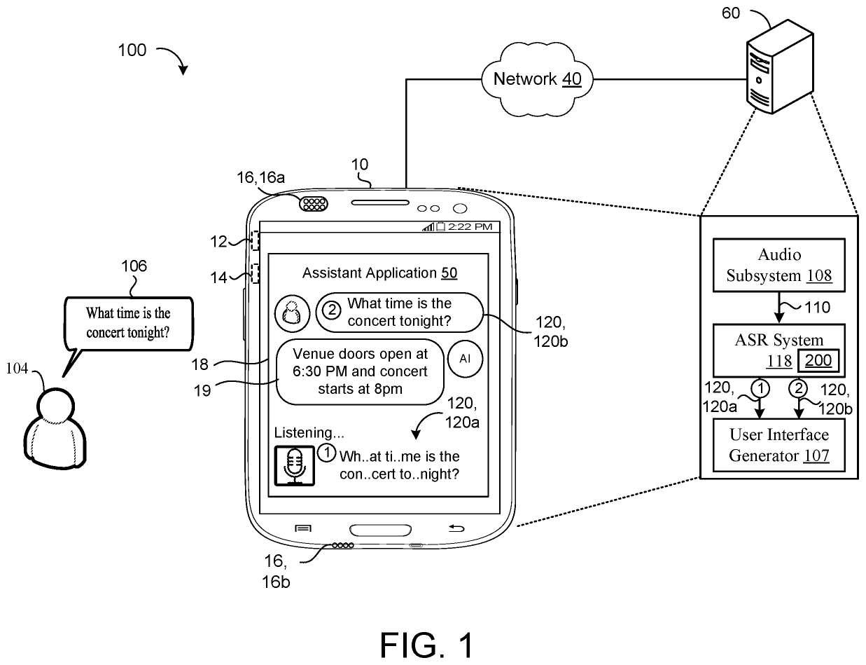

FIG. 1 depicts an example system 100 whereby a user's 104 manner of interacting with a computing device, such as a user device 10, may be through voice input. The user device 10 (also referred to generally as a device 10) is configured to capture sounds (e.g., streaming audio data) from one or more users 104 within the system 100. Here, the streaming audio data may refer to a spoken utterance 106 by the user 104 that functions as an audible query, a command for the user device 10, or an audible communication captured by the device 10. Speech-enabled systems of the user device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and stores instructions, that when executed by the data processing hardware 12, cause the data processing hardware 12 to perform one or more operations. The user device 10 further includes an audio system 16 with an audio capture device (e.g., microphone) 16, 16a for capturing and converting spoken utterances 106 with the system 100 into electrical signals and a speech output device (e.g., a speaker) 16, 16b for communicating with an audible audio signal (e.g., as output data from the user device 10). While the user device 10 may implement an array of audio capture devices 16a without departing from the scope of the present disclosure, whereby one or more capture devices 16a in the array may not physically reside on the user device 10, but be in communication with the audio system 16.

In the system 100, an automated speech recognition (ASR) system 118 implements an ASR model 200 and resides on the user device 10 of the user 104 and/or on a remote computing device 60 (e.g., one or more remote servers of a distributed system executing in a cloud-computing environment) in communication with the user device 10 via a network 40. In some examples, the ASR model 200 may be a recurrent neural network-transducer (RNN-T) model. The ASR model 200 may be multi-domain speech recognition model capable of transcribing utterances 106 from multiple different domains. Moreover, the ASR model 200 may be a monolingual ASR model capable of transcribing speech from a single language or a multilingual ASR model capable of transcribing speech from multiple different languages. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR system 118. In the example shown, the user speaks a respective utterance 106 and the audio subsystem 108 converts the utterance 106 into corresponding audio data (e.g., sequence of acoustic frames) 110 for input to the ASR system 118. Thereafter, the ASR model 200 receives, as input, the sequence of acoustic frames 110 corresponding to the utterance 106, and generates/predicts, at each output step, a corresponding transcription 120 (e.g., speech recognition result/hypothesis) of the utterance 106 as the ASR model receives (e.g., processes) each acoustic frame 110 in the sequence of acoustic frames 110.

In the example shown, the ASR model 200 may perform streaming speech recognition to produce an initial speech recognition result 120, 120a and generate a final speech recognition result 120, 120b by improving the initial speech recognition result 120a. The speech recognition results 120 may either correspond to a partial speech recognition result or an entire speech recognition result. Stated differently, the speech recognition result 120 may either correspond to a portion of an utterance 106 or an entire utterance 106. For example, the partial speech recognition result may correspond to a portion of a spoken utterance or even a portion of a spoken term. However, as will become apparent, the ASR model 200 performs additional processing on the final speech recognition result 120b whereby the final speech recognition result 120b may be delayed from the initial speech recognition result 120a.

The user device 10 and/or the remote computing device 60 also executes a user interface generator 107 configured to present a representation of the transcription 120 of the utterance 106 to the user 104 of the user device 10. As described in greater detail below, the user interface generator 107 may display the initial speech recognition results 120a in a streaming fashion during time 1 and subsequently display the final speech recognition results 120b in a streaming fashion during time 2. Notably, the ASR model 200 outputs the final speech recognition results 120b in a streaming fashion even though the final speech recognition results 120b improve upon the initial speech recognition result 120a. The ASR model 200 may operate in the non-streaming fashion and/or the streaming fashion. In some configurations, the transcription 120 output from the ASR system 118 is processed, e.g., by a natural language understanding (NLU) module executing on the user device 10 or the remote computing device 60, to execute a user command/query specified by the utterance 106. Additionally or alternatively, a text-to-speech system (not shown) (e.g., executing on any combination of the user device 10 or the remote computing device 60) may convert the transcription 120 into synthesized speech for audible output by the user device 10 and/or another device.

In the example shown, the user 104 interacts with a program or application 50 (e.g., the digital assistant application 50) of the user device 10 that uses the ASR system 118. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by audio systems 16 of the user device 10. In this example, the audio system 16 receives the spoken utterance 106 and converts it into a sequence of acoustic frames 110 for input to the ASR system 118.

Continuing with the example, the ASR model 200, while receiving the sequence of acoustic frames 110 corresponding to the utterance 106 as the user 104 speaks, encodes the sequence of acoustic frames 110 and then decodes the encoded sequence of acoustic frames 110 into the initial speech recognition results 120a. During time 1, the user interface generator 107 presents, via the digital assistant interface 18, a representation of the initial speech recognition results 120a of the utterance 106 to the user 104 of the user device 10 in a streaming fashion such that words, word pieces, and/or individual characters appear on the screen as soon as they are spoken. In some examples, the first look ahead audio context is equal to zero.

During time 2, the user interface generator 107 presents, via the digital assistant interface 18, a representation of the final speech recognition results 120b of the utterance 106 to the user 104 of the user device 10 a streaming fashion such that words, word pieces, and/or individual characters appear on the screen as soon as they are generated by the ASR model 200. In some implementations, the user interface generator 107 replaces the representation of the initial speech recognition results 120a presented at time 1 with the representation of the final speech recognition results 120b presented at time 2. Here, time 1 and time 2 may include timestamps corresponding to when the user interface generator 107 presents the respective speech recognition result 120. In this example, the timestamp of time 1 indicates that the user interface generator 107 presents the initial speech recognition results 120a at an earlier time than the final speech recognition results 120b. For instance, as the final speech recognition result 120b is presumed to be more accurate than the initial speech recognition result 120a, the final speech recognition result 120b ultimately displayed as the transcription 120 may fix any terms that may have been misrecognized in the initial speech recognition results 120a. In this example, the streaming initial speech recognition results 120a output by the ASR model 200 are displayed on the screen of the user device 10 at time 1 are associated with low latency and provide responsiveness to the user 104 that his/her query is being processed, while the final speech recognition result 120b output by the ASR model 200 and displayed on the screen at time 2 leverages an additional speech recognition model and/or a language model to improve the speech recognition quality in terms of accuracy, but at increased latency. However, since the initial speech recognition results 120a are displayed as the user speaks the utterance 106, the higher latency associated with producing, and ultimately displaying the final speech recognition results 120b is not noticeable to the user 104.

In the example shown in FIG. 1, the digital assistant application 50 may respond to the question posed by the user 104 using natural language processing. Natural language processing generally refers to a process of interpreting written language (e.g., the initial speech recognition result 120a and/or the final speech recognition result 120b) and determining whether the written language prompts any action. In this example, the digital assistant application 50 uses natural language processing to recognize that the question from the user 104 regards the user's schedule and more particularly a concert on the user's schedule. By recognizing these details with natural language processing, the automated assistant returns a response 19 to the user's query where the response 19 states, “Venue doors open at 6:30 PM and concert starts at 8 pm.” In some configurations, natural language processing occurs on the remote computing device (i.e., remote server) 60 in communication with the data processing hardware 12 of the user device 10.

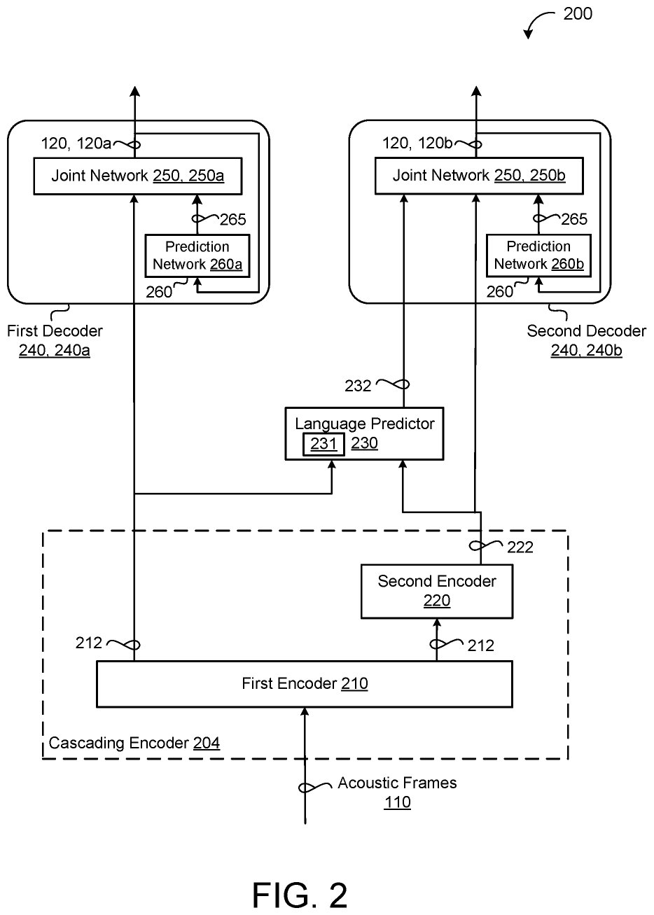

Referring now to FIG. 2, in some implementations, the ASR model 200 includes a cascading encoder 204 and decoders 240. Optionally, the ASR model 200 may include a language ID predictor 230. However, in some scenarios, the ASR model 200 operates without the language ID predictor 230. For instance, the ASR model 200 may be a multilingual ASR model capable of recognizing speech from multiple different languages or a monolingual ASR model capable of recognizing speech from a single language. A first decoder 240, 240a may operate in a streaming fashion such that the first decoder 240a is configured to generate partial speech recognition results corresponding to the initial speech recognition results 120a. On the other hand, a second decoder 240, 240b is configured to improve upon initial speech recognition results 120a output by the first decoder 240a. The second decoder 240b improves upon the partial speech recognition results by receiving additional right-context and generating the final speech recognition results 120b. The first decoder 240a and the second decoder 240b each include a corresponding prediction network 260 followed by a corresponding joint network 250. Here, a first prediction network 260, 260a and a first joint network 250, 250a correspond to the first decoder 240a and a second prediction network 260, 260b and a second joint network 250, 250b corresponds to the second decoder 240b. The prediction networks 260a, 260b have a same structure that includes one of a long short-term memory (LSTM)-based prediction network or a V2 embedding look-up table. Moreover, the corresponding joint networks 250a, 250b have a same structure. Although, while the component structure is the same for the first and second decoders 240a, 240b, the respective components of each decoder 240 are unique and may be trained independently from the components of the other decoder 240.

The cascading encoder 204 refers to a model structure where the encoding pathway includes two encoders 210, 220 that cascade such that the output of a first encoder 210 feeds the input of a second encoder 220 prior to decoding. The first encoder 210 and the second encoder 220 may be trained jointly on a set of multilingual training utterances using a negative log-likelihood loss. Here, the first encoder 210 and the second encoder 220 may be cascaded irrespective of the underlying architecture of each encoder. The encoders 210, 220 may each include a stack of multi-head self-attention layers (i.e., plurality of multi-head attention layers). In particular, the first encoder 210 includes a first plurality of multi-head self-attention layers and the second encoder 220 includes a second plurality of multi-head self-attention layers. In some examples, the first encoder 210 includes a causal encoder whereby the stack of multi-head attention layers include one or more of unidirectional (LSTM) layers, a plurality of conformer layers, or a plurality of transformer layers. For example, the stack of multi-head self-attention layers of the first encoder 210 may include twelve (12) conformer layers each having a multi-headed (e.g., eight (8) heads) self-attention mechanism and a convolution kernel size of fifteen (15). Moreover, the first encoder 210 may perform a concatenation operation after a third conformer layer to achieve a time reduction rate of two whereby the resulting 1024-dimensional vectors are transformed by a fourth conformer layer and then projected back to a 512-dimensional vector using another linear transformation. Thereafter, another eight (8) conformer layers are followed by a final normalization layer. Thus, the first encoder 210 may include 110 million parameters. Each layer of the first encoder 210 receives zero right-context (e.g., receives zero future acoustic frames).

The second encoder 220 includes a non-causal encoder whereby the stack of multi-head self-attention layers include one of one or more bi-directional LSTM layers, a plurality of conformer layers, or a plurality of transformer layers. For instance, the second encoder 220 may include a 512-dimensional linear projection to transform input feature, followed by five (5) 512-dimensional conformer layers and a final linear normalization layer thereby resulting in 50 million parameters. Here, the second encoder 220 may receive additional right-context, for example, a total right context of fifteen (15) frames whereby each conformer layer receives three (3) frames of right-context.

With continued reference to FIG. 2, the first encoder 210 receives a sequence of d-dimensional feature vectors (e.g., sequence of acoustic frames 110) x=(x₁, x₂, . . . , x_{T}), where xₜ∈ [symbol] d, and generates, at each output step, a first higher order feature representation 212 for a corresponding acoustic frame 110 in the sequence of acoustic frames 110. Similarly, the second encoder 220 is connected in cascade to the first encoder 210, and receives the first higher order feature representation 212 as input, and generates, at each output step, a second higher order feature representation 222 for a corresponding first higher order feature representation 212. In some instances, the second encoder 220 generates the second higher order feature representation 222 without receiving any of the acoustic frames 110 as input. In these instances, the second encoder 220 generates the second higher order feature representations 222 using only the first higher order feature representation 212 as input. Thus, the first higher order feature representations 212 output from the first encoder 210 are fed to the language ID predictor 230 and the first decoder 240a while the second higher order feature representations 222 output from the second encoder 220 are fed to the second decoder 240b and the language ID predictor 230. However, in configurations where the ASR model 200 does not include the language ID predictor 230, the first higher order feature representation 212 and the second higher order feature representation 222 are fed to the first decoder 240a and the second decoder 204b, respectively, and are not fed to the language ID predictor 230.

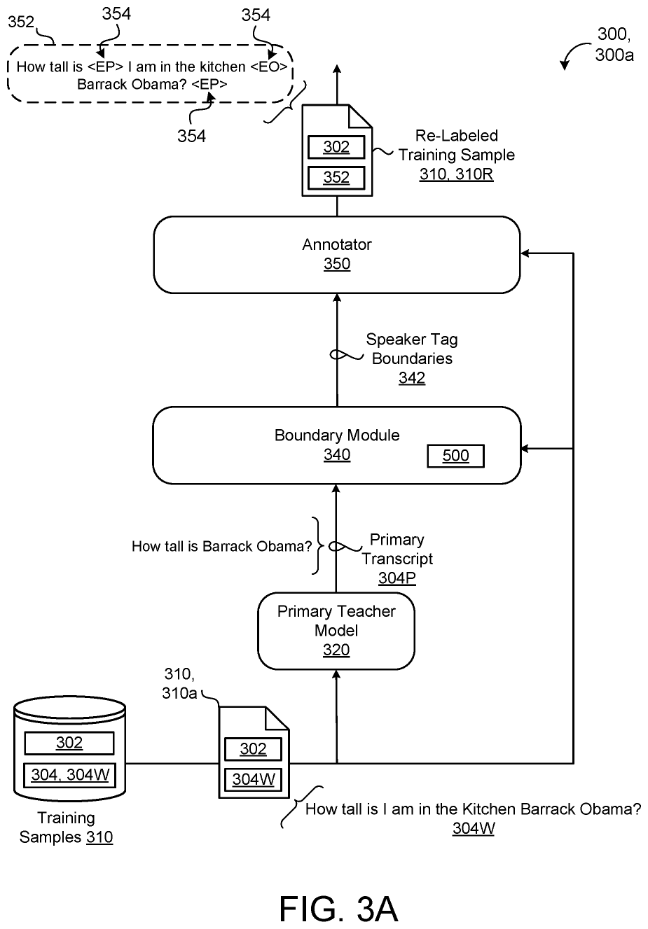

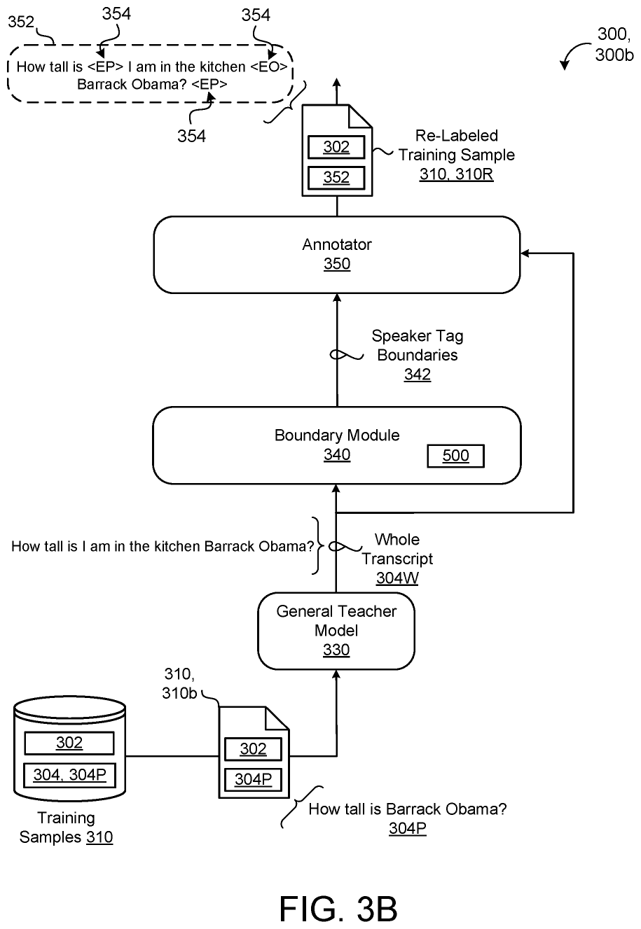

With continued reference to FIG. 2, the first decoder 240a includes the first joint network 250a and the first prediction network 260a. The first joint network 250a is configured to receive, as input, a dense representation 265 generated by the first prediction network 260a and the first higher order feature representation 212 generated by the first encoder 210 and generate, at each output step, the initial speech recognition result 120a for a corresponding acoustic frame 110. Here, the first joint network 250a generates the initial speech recognition result 120a using the first higher order feature representation 212 and the dense representation 265. As will become apparent, the initial speech recognition result 120a includes at least one of wordpiece tokens, a blank token, or a speaker tag 354 (FIGS. 3A and 3B). The first decoder 240a operates in a streaming fashion such that the first decoder 240a such that the initial speech recognition results 120a may correspond to partial speech recognition results.

In some implementations, the initial speech recognition result 120a includes a first probability distribution over possible speech recognition hypotheses. As such, the initial speech recognition result 120a may be used interchangeably with the first probability distribution 120a over possible speech recognition hypotheses herein. Thus, the first joint network 250a may generate, at each output step (e.g., time step), a first probability distribution 120a over possible speech recognition hypotheses. Here, the “possible speech recognition hypotheses” correspond to a set of output labels/symbols (also referred to as “speech units”) each representing a grapheme (symbol/character) or a word piece in a specified natural language. For example, when the natural language is English, the set of output labels may include twenty-eight (28) symbols, e.g., one label for each of the 26-letters in the English alphabet, one label designating a space, and a speaker tag 354 (FIGS. 3A and 3B). Accordingly, the first joint network 250a may output a set of values indicative of the likelihood of occurrence of each of a predetermined set of output labels. The set of values can be a vector (e.g., a one-hot vector) and can indicate a second probability distribution over the set of output labels. In some scenarios, the output labels are graphemes (e.g., individual characters, and potentially punctuation and other symbols), but the set of output labels is not so limited. For example, the set of output labels can include wordpieces and/or entire words, in addition to or instead of graphemes. The output labels could also be other types of speech units, such as phonemes or sub-phonemes. The first probability distribution 120a of the first joint network 250a can include a posterior probability value for each of the different output labels. Thus, if there are 100 different output labels representing different graphemes or other symbols, the output of the joint network 250 can include 100 different probability values, one for each output label. The first probability distribution 120a can then be used to select and assign scores to candidate orthographic elements (e.g., graphemes, wordpieces, and/or words) in a beam search process (e.g., by a final Softmax layer of the first joint network 250a (not shown)) for determining the initial speech recognition result 120a. For example, the first joint network 250a may select the N-best possible speech recognition hypotheses having the highest probabilities as output for the initial speech recognition result 120a.

In some implementations, the first prediction network 260a receives, as input, a sequence of non-blank symbols output by the final softmax layer of the first joint network 250a and generates, at each output step, a dense representation 265. Notably, in contrast to conventional prediction networks, the sequence of non-blank symbols received by the first prediction network 260a includes speaker tags 354 such that the first prediction network 260a is conditioned on the speaker tags 354 and generates the dense representation based on the sequence of non-blank output symbols. That is, the first joint network 250a receives the dense representation 265 for the previous initial speech recognition result 120a and generates a subsequent initial speech recognition result 120a using the dense representation 265.

In some configurations, the language ID predictor 230 of the ASR model 200 is configured to receive, as input, the first higher order feature representation 212 generated by the first encoder 210 at each of the plurality of output steps and the second higher order feature representation 222 generated by the second encoder 220 at each of the plurality of output steps. Moreover, the language ID predictor 230 may generate a concatenation 231 of the first higher order feature representation 212 and the second higher order feature representation 222. Thereafter, the language ID predictor 230 is further configured to generate, at each of the plurality of output steps, a language prediction representation 232 based on the concatenation 231 of the first higher order feature representation 212 and the second higher order feature representation 222. Advantageously, by generating the concatenation 231, the language ID predictor 230 uses a diversity of inputs to generate the language prediction representation 232.

The language prediction representation 232 indicates a corresponding language of the utterance spoken. For instance, because the ASR model 200 is a multilingual ASR model, the spoken utterance may be in any number of languages. Thus, using the concatenation 231, the language ID predictor 230 predicts the corresponding language of the spoken utterance. The language prediction representation 232 may be used for downstream tasks (e.g., code-switching or speech translation) and/or to improve speech recognition results. That is, the second decoder 240b may use the language prediction representation 232 to improve upon the initial speech recognition results 120a generated by the first decoder 240a. In some examples, the language ID predictor 230 generates the language prediction representation 232 on a per-frame basis. In these examples, the spoken utterance may include multiple utterances and the language ID predictor 230 generates the language prediction representation 232 for each acoustic frame 110 in the sequence of acoustic frames 110. For example, for a first portion of the sequence of acoustic frames the language prediction representation 232 may indicate a first language was spoken while for a second portion of the sequence of acoustic frames the language prediction representation 232 indicates a second language was spoken.

With continued reference to FIG. 2, the second decoder 240b includes the second joint network 250b and the second prediction network 260b. In some configurations, the second joint network 250b is configured to receive, as input, a dense representation 265 generated by the second prediction network 260b, the second higher order feature representation 222 generated by the second encoder 220, and the language prediction representation 232 generated by the language ID predictor 230, and generate, at each output step, the final speech recognition results 120b for a corresponding acoustic frame 110. Here, the second joint network 250b generates the final speech recognition result 120b using the second higher order feature representation 222, the language prediction representation 232, and the dense representation 265. As will become apparent, the final speech recognition result 120b includes at least one of wordpiece tokens, a blank token, or a speaker tag 354 (FIGS. 3A and 3B). In some configurations, the second joint network 250b generates the final speech recognition result 120b without using the language prediction representation 232. In some examples, the second decoder 240b generates a concatenation of the second higher order feature representation 222 and the language prediction representation 232 and uses the concatenation to generate the final speech recognition result 120b.

In some implementations, the final speech recognition result 120b includes a second probability distribution over possible speech recognition hypotheses. As such, the final speech recognition result 120b may be used interchangeably with the second probability distribution 120b over possible speech recognition hypotheses herein. Thus, the second joint network 250b may generate, at each output step (e.g., time step), a second probability distribution 120b over possible speech recognition hypotheses. Here, the “possible speech recognition hypotheses” correspond to a set of output labels/symbols (also referred to as “speech units”) each representing a grapheme (symbol/character) or a word piece in a specified natural language. For example, when the natural language is English, the set of output labels may include twenty-eight (28) symbols, e.g., one label for each of the 26-letters in the English alphabet, one label designating a space, and a speaker tag 354. Accordingly, the second joint network 250b may output a set of values indicative of the likelihood of occurrence of each of a predetermined set of output labels. The set of values can be a vector (e.g., a one-hot vector) and can indicate a first probability distribution over the set of output labels. In some scenarios, the output labels are graphemes (e.g., individual characters, and potentially punctuation and other symbols), but the set of output labels is not so limited. For example, the set of output labels can include wordpieces and/or entire words, in addition to or instead of graphemes. The output labels could also be other types of speech units, such as phonemes or sub-phonemes. The second probability distribution 120b of the second joint network 250b can include a posterior probability value for each of the different output labels. Thus, if there are 100 different output labels representing different graphemes or other symbols, the output of the second joint network 250b can include 100 different probability values, one for each output label. The second probability distribution 120b can then be used to select and assign scores to candidate orthographic elements (e.g., graphemes, wordpieces, and/or words) in a beam search process (e.g., by a final Softmax layer of the second joint network 250b (not shown)) for determining the final speech recognition result 120b. For example, the second joint network 250b may select the N-best possible speech recognition hypotheses having the highest probabilities as output for the final speech recognition result 120b.

In some implementations, the second prediction network receives, as input, a sequence of non-blank symbols output by the final softmax layer of the second joint network 250b and generates, at each output step, a dense representation 265. Notably, in contrast to conventional prediction networks, the sequence of non-blank symbols received by the second prediction network 260b includes speaker tags 354 such that the second prediction network 260b is conditioned on the speaker tags 354 and generates the dense representation 265 based on the sequence of non-blank output symbols. That is, the second joint network 250b receives the dense representation 265 for the previous final speech recognition result 120b and generates a subsequent final speech recognition result 120b using the dense representation 265.

In some implementations, the language ID predictor 230 generates more accurate language prediction representations 232 using more acoustic information (e.g., longer audio features). Thus, to utilize all past acoustic frames 110 but still generate the language prediction representations 232 on a per-frame basis, the language ID predictor 230 uses non-parametric statistics pooling. That is, the language ID predictor 230 converts the first higher order feature representation 212 into a concatenation of a mean (μₜ) and standard deviation (σₜ) of the first higher order feature representation 212. Notably, the language ID predictor 230 determines the mean and standard deviation in a streaming fashion represented by:

$${μ}_{t} = \frac{θ ( {h}_{1 : t} )}{t} \qquad ( 1 )$$

$${σ}_{t}^{2} = \frac{( θ ( {h}_{1 : t}^{2} ) - 2 {μ}_{t} θ ( {h}_{1 : t} ) + t {μ}_{t}^{2} )}{t} \qquad ( 2 )$$

In Equations 1 and 2, hi represents the first higher order feature representation 212. After converting the first higher order feature representation 212 into a concatenated vector [μₜ; σₜ] with statistics pooling, the language ID predictor 230 transforms the concatenated vector into the language prediction representation 232 using two fully connected layers followed by a softmax output layer. As such, the frame-synchronous language ID predictor 230 is efficient for operating in a streaming fashion and only requires a small amount of computational cost during execution.

In some implementations, the ASR model 200 jointly trains the first encoder 210, the second encoder 220, and the language ID predictor 230 on a set of multilingual training utterances. Here, a language ID target token is added as a first token of a corresponding ground-truth transcription of each multilingual training utterance in the set of multilingual training utterance. The language ID target token identifies a language of the corresponding multilingual training utterances. That is, the set of multilingual training utterances may include training utterances in any number of different languages and the language ID target token identifies the actual language (e.g., ground-truth label) of the multilingual training utterance for training purposes.

During training, a training process generates a first loss for the first encoder 210 and a second loss for the second encoder 220 represented by:

$${ℒ}^{rnnt} = ln P ( y \vert {x}_{1 : T} ) \qquad ( 3 )$$

$$P ( y \vert {x}_{1 : T} ) = {\sum }_{\hat{y} ∈ A ( {x}_{1 : T} , y )} {\prod }_{i = 1}^{T + U} P ( {\hat{y}}_{i} \vert {x}_{1 : {t}_{i}} , {y}_{1 : {u}_{i}} ) \qquad ( 4 )$$

In Equations 3 and 4, [symbol] ^{rnnt} represents the loss (e.g., Recurrent Neural Network-Transducer loss) of the decoders 240, x represents the sequence of acoustic frames 110, y represents the transcription 120. The ASR model 200 uses two separate decoders 240, and thus, the training loss of the ASR model 200 is represented by:

$${ℒ}^{casc} = {λℒ}^{1 st} + ( 1 - λ ) {ℒ}^{2 nd} \qquad ( 5 )$$

In Equation 5, [symbol] ist represents the loss of the first decoder 240a, [symbol] ^{2nd} represents the loss of the second decoder 240b, λ represents the weighting factor of the loss of the first decoder 240a, and (1−λ) represents the weighting factor of the loss of the second decoder 240b. Moreover, the training process generates a third loss for the language ID predictor 230 represented by:

$${ℒ}^{lid} - {l}_{t} ln ( \frac{{l}_{t}}{{z}_{t}} ) \qquad ( 6 )$$

In Equation 6, [symbol] ^{lid} represents the third loss for the language ID predictor 230 and lₜ represents a one-hot language prediction representation label of t. As such, the training process trains the ASR model 200 using the final training loss according to:

$${ℒ}^{asr + lid} = {ℒ}^{casc} + {αℒ}^{lid} \qquad ( 7 )$$

In Equation 7, α is a scalar weight for the loss for the language ID predictor 230. Thus, the training process trains the ASR model 200 by minimizing a weighted sum of the first loss, the second loss, and the third loss.

FIGS. 3A and 3B are schematic views of an example training data re-labeling process 300 that is configured to re-label a plurality of training samples 310 spanning multiple different domains. Each corresponding training sample 310 from the plurality of training samples 310 includes audio data 302 characterizing an utterance 106 (FIG. 1) that is paired with a corresponding transcription 304 of the utterance 106. The audio data 302 may include speech spoken by a human (e.g., non-synthetic speech) and/or speech output by a text-to-speech system (e.g., synthetic speech). The multiple different domains may include a short-form query domain and a dictation domain.

The short-form query domain may include spoken utterances of short requests directed to a voice assistant and/or short queries directed to a search engine. For example, a short request directed towards the voice assistant may include “call mom,” “schedule a meeting for tomorrow,” and “play my playlist,” to name a few. On the other hand, a short query directed towards a search engine may include “what is the capital of Utah?” “who was the sixth president of the United States?” and “where is the Super Bowl being played this year?” to name a few. Notably, for the short-form query domain, speech-related applications are only concerned with speech spoken by a primary speaker. That is, the voice assistant and the search engine should only transcribe speech spoken by a primary speaker that speaks towards a target application (e.g., voice assistant or search engine) and ignore any background noise or speech spoken by other speakers (e.g., speech spoken by a non-primary speaker). Speech spoken by the primary speaker corresponds to speech directed toward the target application (e.g., voice assistant or search bar). On the other hand, speech spoken by the non-primary speaker includes any one of background speech spoken by a speaker other than the primary speaker, recorded or broadcasted speech emanating from an audio output device (e.g., audio output from a smart speaker, television, or radio), or synthesized speech (e.g., output from a text-to-speech system).

The dictation domain may include spoken utterances of a user dictating a long-form query directed towards a dictation assistant. The long-form query may be for composing an email or message by speaking instead of typing. In contrast to the short-form query domain which includes short spoken utterances (e.g., lasting a few seconds), the dictation domain may include long spoken utterances (e.g., lasting a few seconds to several minutes). Similarly to the short-form query domain, speech-related applications are only concerned with speech spoken by the primary speaker for the dictation domain. That is, the dictation assistant should only transcribe speech spoken by the primary speaker that speaks towards a target application (e.g., dictation assistant) and ignore any background noise or speech spoken by other speakers (e.g., speech spoken by a non-primary speaker).

In some examples, the multiple different domains further include a captions domain. The captions domains may include, but is not limited to, speech spoken during a video, podcast, and/or livestream. In contrast to the short-form query domain and the dictation domain, speech-related applications are concerned with speech spoken by the primary speaker and other speakers for the captions domain. For instance, when captioning a podcast with multiple speakers, the speech-related application transcribes speech for all speakers and not only the primary speaker. That is, the target application aims to transcribe all speech for the captions domain.

The corresponding transcription 304 for each training sample 310 may include a whole transcript 304, 304W (FIG. 3A) of all speech present in the corresponding audio data 302 and/or a primary transcript 304, 304P (FIG. 3B) of only speech spoken by a primary speaker in the corresponding audio data 302. For instance, training samples 310 from the short-form query domain and the dictation domain may include corresponding transcriptions 304 that only include speech spoken by the primary speaker despite other speakers also speaking during the audio data 302. On the other hand, training samples 310 from the dictation domain may include corresponding transcriptions 304 that include speech spoken by the primary speaker and other speakers (e.g., all speech) during the audio data 302.

To that end, the training data re-labeling process (i.e., re-labeling process) 300 includes a primary teacher speech recognition model 320 (FIG. 3A) and/or a general teacher speech recognition model 330 (FIG. 3B). The primary teacher speech recognition model 320 is a bidirectional model that is trained on supervised training data obtained from domains that require only a primary speaker transcript (e.g., the primary transcript 304P). Thus, the primary teacher speech recognition model 320 is trained to recognize speech spoken by primary speakers and ignore/discard speech spoken by other speakers. The supervised training data that the primary teacher speech recognition model 320 is trained on may be the same or different as the short-form query and dictation training samples from the plurality of training samples 310. In short, the primary teacher speech recognition model 320 is trained to generate primary transcripts 304P of only speech spoken by the primary speaker in the corresponding audio data 302 and discard speech spoken by other speakers. To that end, the primary teacher speech recognition model 320 is configured to receive training samples 310 that have a corresponding transcription 304 that includes only a whole transcript 304W of all speech present in the corresponding audio data 302 and process each received training sample 310 to obtain (i.e., generate) a primary transcript 304P of only the speech spoken by a primary speaker in the corresponding audio data 302. That is, training samples 310 sampled from the captions domain include the whole transcript 304W since the captions domain transcribes speech spoken by all speakers, and thus, the primary teacher speech recognition model 320 generates primary transcripts 304P for these training samples 310. As will become apparent, re-labeling the corresponding training samples 310 that include only the whole transcript 304W is based on the primary transcript 304P generated by the primary teacher speech recognition model 320 and the whole transcript 304W paired with the associated audio data 302.

The general teacher speech recognition model 330 is a bidirectional model that is trained on a training data set to teach the general teacher speech recognition model 330 to recognize primary speech (e.g., speech spoken by a primary speaker), secondary speech (e.g., speech spoken by speakers other than the primary speaker), and background noise speech (e.g., audio output by a television, radio, etc.). The training data set that the general teacher speech recognition model 330 is trained on may be the same or different as the dictation training samples from the plurality of training samples 310. In short, the general teacher speech recognition model 330 is trained to generate whole transcripts 304W of only all speech spoken during the corresponding audio data 302 including speech by the primary speaker and other speakers. Accordingly, the general teacher speech recognition model 330 is configured to receive training samples 310 that have a corresponding transcription 304 that includes only a primary transcript 304P of speech spoken by a primary speaker in the corresponding audio data 302 and omits transcripts of any other speech in the corresponding audio data 302 not spoken by the primary speaker and process each received training sample 310 to obtain (i.e., generate) a corresponding whole transcript 304W of all speech present in the corresponding audio data 302. As will become apparent, re-labeling the corresponding training samples 310 that include only the primary transcript 304P is based on the whole transcript 304W generated by the general teacher speech recognition model 330 and the primary transcript 304P paired with the associated audio data 302.

As such, in some scenarios, a respective training sample 310 may correspond to the captions domain whereby the corresponding transcription 304 includes only a whole transcript 304W (FIG. 3A) of all speech present in the corresponding audio data 302 (e.g., no primary transcript 304P exists for the respective training sample 310). In these scenarios, the primary teacher speech recognition model 320 processes the respective training sample 310 corresponding to the captions domain to generate a corresponding primary transcript 304P of only speech spoken by the primary speaker that discards speech spoken by any other speaker. In other scenarios, a respective training sample 310 may correspond to the short-form query domain or the dictation domain where the corresponding transcription 304 includes only a primary transcript 304P (FIG. 3B) of speech spoken by the primary speaker. In these other scenarios, the general teacher speech recognition model 330 processes the respective training sample 310 corresponding to the short-form query domain or the dictation domain to generate a corresponding whole transcript 304W of all speech present in the corresponding audio data 302. In short, training samples 310 that have a primary transcript 304P do not have a whole transcript 304W such that the general teacher speech recognition model 330 needs to generate the whole transcript 304W. Similarly, training samples 310 that have a whole transcript 304W do not have a primary transcript 304P such that the primary teacher speech recognition model 320 needs to generate the primary transcript 304P.

In the examples shown in FIGS. 3A and 3B, the primary teacher speech recognition model 320 and the general teacher speech recognition model 330 receive training samples 310 each including the same respective audio data 302 corresponding to “How tall is I am in the kitchen Barrack Obama?” In this example, the terms “how tall is Barrack Obama” were spoken by a primary speaker and the terms “I am in the kitchen” were spoken by another speaker which is intermixed with the speech spoken by the primary speaker. Here, the phrase “How tall is Barrack Obama” corresponds to a primary transcript 304P spoken by the primary speaker. Moreover, the phrase “I am in the kitchen” was spoken by another speaker (e.g., different than the primary speaker) as the primary speaker was speaking. As such, the corresponding whole transcript 304W of the respective audio data 302 includes “How tall is I am in the kitchen Barrack Obama?”

Referring now specifically to FIG. 3A, in this example, the primary teacher speech recognition model 320 receives a first training sample 310, 310a that includes the respective audio data 302 paired with the corresponding whole transcript 304W of “How tall is I am in the kitchen Barrack Obama.” The primary teacher speech recognition model 320 processes the first training sample 310a to generate a corresponding primary transcript 304P of “How tall is Barrack Obama?” Notably, the corresponding primary transcript 304P omits the speech of “I am in the kitchen” which was spoken by the other speaker and not spoken by the primary speaker. The primary teacher speech recognition model 320 may generate the corresponding primary transcript 304P by processing the respective audio data 302 and/or the whole transcript 304W of the first training sample 310a.

Referring now specifically to FIG. 3B, continuing with the example shown, the general teacher speech recognition model 330 receives a second training sample 310, 310b that includes the respective audio data 302 paired with the corresponding primary transcript 304P of “How tall is Barrack Obama?” The general teacher speech recognition model 330 processes the second training sample 310b to generate a corresponding whole transcript 304W of “How tall is I am in the kitchen Barrack Obama?” Notably, the corresponding whole transcript 304W includes textual representations for speech spoken by the primary speaker and speech spoken by the other speaker. The general teacher speech recognition model 330 may generate the corresponding whole transcript 304W by processing the respective audio data 302 and/or the primary transcript 304P of the second training sample 310b.

Referring again to FIGS. 3A and 3B, the re-labeling process 300 also includes a boundary module 340 configured to identify one or more speaker tag boundaries 342 for each training sample 310. In some examples, each speaker tag boundary 342 indicates a transition point where the primary speaker or the other speakers stop speaking. In other examples, each speaker tag boundary 342 indicates a transition point where the primary speaker or the other speakers start speaking. In particular, the boundary module 340 performs a sub-sequence match 500 between the whole transcript 304W and the primary transcript 304P to identify the one or more speaker tag boundaries 342 for each training sample 310.

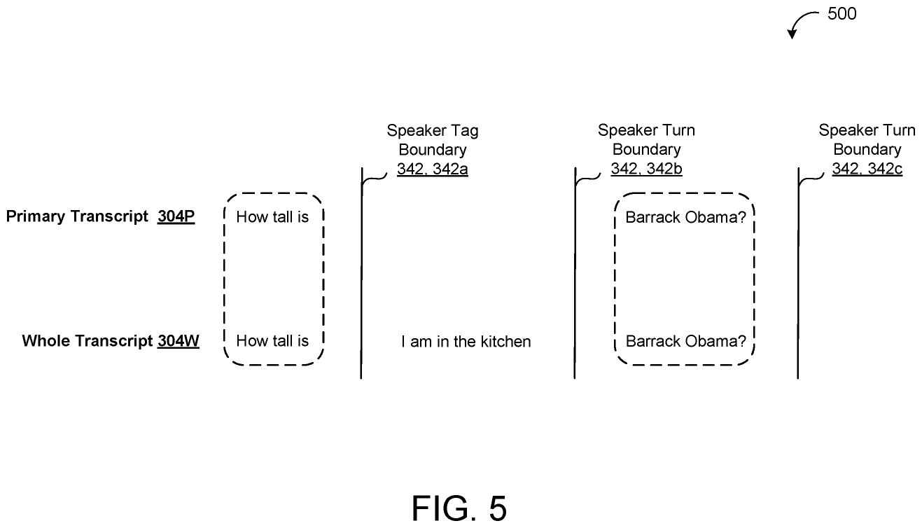

FIG. 5 illustrates an example sub-sequence match process 500. In the example shown, the sub-sequence match process 500 compares the whole transcript 304W of “how tall is I am in the Kitchen Barrack Obama?” with the primary transcript 304P of “how tall is Barrack Obama?” to identify speaker tag boundaries 342. More specifically, the sub-sequence match process 500 identifies segments between the whole transcript 304W and the primary transcript 304P that match and do not match. That is, the sub-sequence match process 500 identifies words or speech recognition tokens shared by both the primary transcript 304P and the whole transcript 304W. In the example shown, the sub-sequence match process 500 identifies the segments of “how tall is” and “Barrack Obama?” as matching segments between the primary transcript 304P and the whole transcript 304W and identifies the segment of “I am in the kitchen” as a non-matching segment included only in the whole transcript 304W. Using the matching and non-matching segments, the sub-sequence match process 500 identifies the one or more speaker tag boundaries 342 that represents a transition point where either the primary speaker or the other speakers stop speaking. Continuing with the example shown, the sub-sequence match process 500 identifies a first speaker tag boundary 342, 342a between the matching segment of “how tall is” and the non-matching segment of “I am in the kitchen”, a second speaker tag boundary 342, 342b between the non-matching segment of “I am in the kitchen” and the matching segment of “Barrack Obama?” and a third speaker tag boundary 342, 342c after the matching segment of “Barack Obama?”

Referring again to FIGS. 3A and 3B, in some examples, the boundary module 340 obtains a respective whole transcript 304W directly from the plurality of training samples 310 (e.g., without the general teacher speech recognition model 330 generating the respective whole transcript 304W) and obtains the primary transcript 304P generated by the primary teacher speech recognition model 320 by processing the associated training sample 310 (FIG. 3A). In other examples, the boundary module 340 obtains a respective primary transcript 304P directly from the plurality of training samples 310 (e.g., without the primary teacher speech recognition model 320 generating the respective primary transcript 304P) and obtains the whole transcript 304W generated by the general teacher speech recognition model 330 by processing the associated training sample 310 (FIG. 3B).

The boundary module 340 sends the identified one or more speaker tag boundaries 342 to the annotator 350. The annotator 350 is configured to annotate the whole transcript 304W with one or more speaker tags 354 based on the identified one or more speaker tag boundaries 342 identified by the boundary module 340 by performing the sub-sequence match between the whole transcript 304W and the primary transcript 304P. In some examples, the annotator 350 annotates the whole transcript 304W generated by the general teacher speech recognition model 330 (FIG. 3B). In other examples, the annotator 350 annotates the whole transcript 304W obtained directly from the plurality of training samples 310 (FIG. 3A) (e.g., the general teacher speech recognition model 330 did not generate the whole transcript 304W). Each speaker tag 354 indicates a respective segment of the transcription 304 for speech that was spoken by a particular type of speaker. The particular type of speaker indicated by each speaker tag 354 may include a primary speaker or a non-primary speaker.

In the examples shown, the annotator 350 receives the whole transcript 304W of “How tall is I am in the kitchen Barrack Obama?” and the one or more speaker tag boundaries 342 identified by the boundary module 340 using the sub-sequence match process 500 and generates, as output, a re-labeled training sample 310, 310R. More specifically, the annotator 350 annotates the whole transcript 304W by classifying each of the one or more speaker tag boundaries 342. In some examples, the annotator 350 classifies each speaker tag boundary 342 as either an end-primary (e.g., EP) boundary indicating the primary speaker has stopped speaking or an end-others (e.g., EO) boundary indicating the other speakers have stopped speaking. In other examples, the annotator 350 classifies each speaker tag boundary 342 as either a start-primary (e.g., SP) boundary indicating the primary speaker has started speaking or a start-others (e.g., SO) boundary indicating the other speakers have started speaking. The annotator 305 uses the classified speaker tag boundaries 342 to generate each speaker tag 354 indicating the particular type of speaker that spoke the respective segment of the transcription 304. Continuing with the example shown, the annotator 350 classifies the first speaker tag boundary 342a (FIG. 5) as an EP boundary, the second speaker tag boundary 342b (FIG. 5) as an EO boundary, and the third speaker tag boundary 342c (FIG. 5) as an EP boundary. Accordingly, the re-labeled training sample 310R for the respective training sample 310 in the example shown includes the same audio data 302 and the annotated whole transcription 352 which includes the whole transcription 304W with the annotated speaker tags 354. The re-labeling process 300 re-labels each training sample 310 in the plurality of training samples 310.

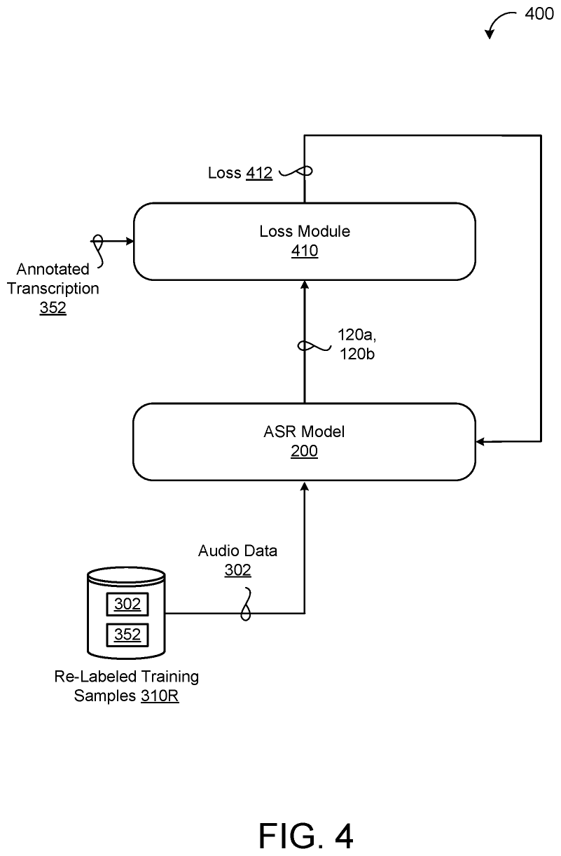

Referring now to FIG. 4, in some implementations, a training process 400 trains the ASR model (e.g., multi-domain speech recognition model) 200 on the re-labeled training samples 310R generated by the re-labeling process 300 (FIG. 3) to teach the ASR model 200 to learn to share parameters for recognizing speech across each of the multiple different domains from the plurality of training samples 310 (FIG. 3). The respective audio data 302 of each re-labeled training sample is paired with the annotated whole transcript 352. The ASR model 200 may receive the respective audio data 302 of each re-labeled training sample 310R and generate a corresponding transcription 120 based on the respective audio data 302. The ASR model 200 may generate a corresponding initial speech recognition result 120a and/or a final speech recognition result 120b based on the respective audio data 302 for each re-labeled training sample 310R. Notably, the ASR model 200 generates the corresponding initial speech recognition result 120a and/or a final speech recognition result 120b using the prediction network 260 which is conditioned on the sequence of non-blank symbols output by the final softmax layer of the joint network 250 which includes the speaker tags 354. That is, during training the ASR model 200 learns to predict the transcriptions 120 which include textual representations of what was spoken in addition to the speaker tags 354 included in each re-labeled training sample 310R.

The training process 400 includes a loss module 410 which receives the transcriptions 120a, 120b generated for each respective re-labeled training sample 310R and determines a loss 412 based on the transcriptions 120a, 120b and the corresponding annotated transcription 352 for the respective re-labeled training sample 310R. More specifically, the loss 412 may include an initial loss term based on the initial speech recognition results 120a and the corresponding annotated transcription 352 and a final loss term based on the final speech recognition results 120b and the corresponding annotated transcription 352. The loss module 410 back-propagates the loss 412 to the ASR model 200 which updates parameters of the ASR model based on the loss 412 generated for each re-labeled training sample 310R. Notably, the training process 400 trains the ASR model 200 without using a domain identifier. Instead, the training process 400 trains the ASR model 200 on each of the re-labeled training samples 310R which includes re-labeled training samples from the multiple different domains. By training the ASR model 200 on the re-labeled training samples 310R, the ASR model 200 learns to share parameters for recognizing speech across each of the multiple different domains.

Accordingly, during inference the ASR model 200 may generate transcriptions 120 for speech from multiple different domains whereby the transcriptions 120 include predicted terms and speaker tags 354 such that the ASR model 200 (or a downstream application) may post process the transcription 120 based on the speaker tags 354. For instance, a virtual assistant or dictation application post processes the transcriptions 120 by removing any transcript that the speaker tags 354 indicate was spoken by a speaker other than the primary speaker. On the other hand, a captions assistant post processes the transcriptions 120 by determining not to remove any transcripts from the transcriptions 120 such that all speech is included in the transcriptions 120.

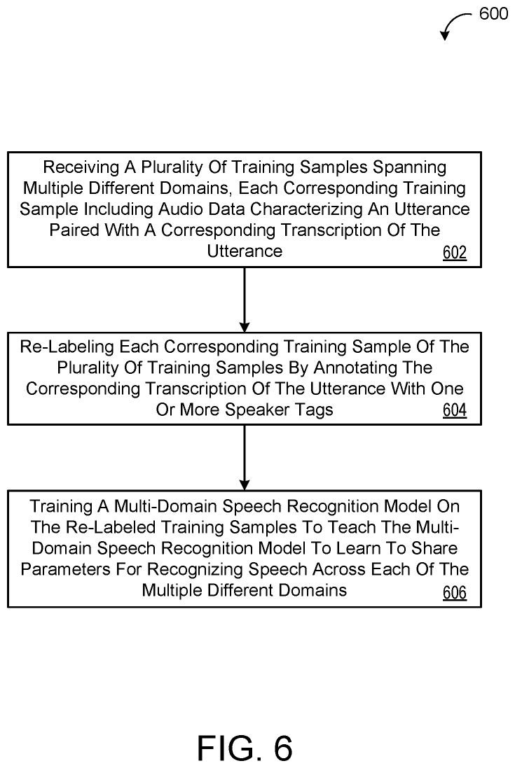

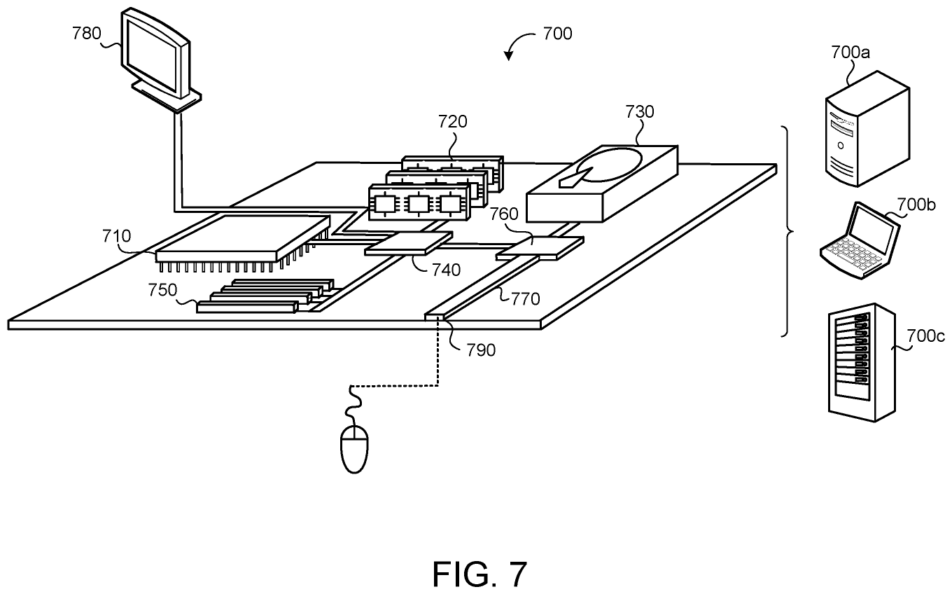

FIG. 6 is a flowchart of an example arrangement of operations for a computer-implemented method 600 of connecting different ASR application domains with speaker tags. The method 600 may execute on data processing hardware 710 (FIG. 7) using instructions stored on memory hardware 720 (FIG. 7). The data processing hardware 710 and the memory hardware 720 may reside on the user device 10 and/or the remote computing device 60 of FIG. 1 each corresponding to a computing device 700 (FIG. 7).

At operation 602, the method 600 includes receiving a plurality of training samples 310 spanning multiple different domains. Each corresponding training sample 310 includes audio data 302 characterizing an utterance 106 paired with a corresponding transcription 304 of the utterance 106. At operation 604, the method 600 includes re-labeling each corresponding training sample 310 of the plurality of training samples 310 by annotating the corresponding transcription 304 of the utterance 106 with one or more speaker tags 354. Each speaker tag 354 indicates a respective segment of the transcription 304 for speech that was spoken by a particular type of speaker. At operation 608, the method 600 includes training a multi-domain speech recognition model 200 on the re-labeled training samples 310R to teach the multi-domain speech recognition model 200 to learn to share parameters for recognizing speech across each of the multiple different domains.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a plurality of training samples spanning multiple different domains, each corresponding training sample comprising audio data characterizing an utterance paired with a corresponding transcription of the utterance;
re-labeling each corresponding training sample of the plurality of training samples by annotating the corresponding transcription of the utterance with one or more speaker tags, each speaker tag indicating a respective segment of the transcription for speech that was spoken by a particular type of speaker; and
training a multi-domain speech recognition model on the re-labeled training samples to teach the multi-domain speech recognition model to learn to share parameters for recognizing speech across each of the multiple different domains.

2. The computer-implemented method of claim 1, wherein the multiple different domains comprise:
a short-form query domain; and
a dictation domain.

3. The computer-implemented method of claim 2, wherein the multiple different domains further comprise a captions domain.

4. The computer-implemented method of claim 1, wherein the corresponding transcription for each training sample comprises at least one of:
a whole transcript of all speech present in the corresponding audio data; or
a primary transcript of only speech spoken by a primary speaker in the corresponding audio data.

5. The computer-implemented method of claim 4, wherein re-labeling each corresponding training sample of the plurality of training samples comprises:
performing a sub-sequence match between the whole transcript and the primary transcript to identify one or more speaker tag boundaries; and
annotating the whole transcript with the one or more speaker tags based on the one or more speaker tag boundaries identified by performing the sub-sequence match between the whole transcript and the primary transcript.

6. The computer-implemented method of claim 1, wherein the particular type of speaker indicated by each speaker tag comprises a primary speaker or a non-primary speaker.

7. The computer-implemented method of claim 6, wherein:
speech spoken by the primary speaker corresponds to speech directed toward a target application; and
speech spoken by the non-primary speaker comprises at least one of:
background speech spoken by a speaker other than the primary speaker;
recorded or broadcasted speech emanating from an audio output device; or
synthesized speech.

8. The computer-implemented method of claim 1, wherein the operations further comprise, for each training sample of the plurality of training samples having a corresponding transcription that comprises only a primary transcript of speech spoken by a primary speaker in the corresponding audio data and omits transcripts of any other speech in the corresponding audio data not spoken by the primary speaker:
processing, using a general teacher speech recognition model, the corresponding audio data to obtain a whole transcript of all speech present in the corresponding audio data,
wherein re-labeling the corresponding training sample comprises re-labeling the corresponding training sample based on the primary transcript and the whole transcript.

9. The computer-implemented method of claim 8, wherein the general teacher speech recognition model is trained on a training data set to teach the general teacher speech recognition model to recognize primary speech, secondary speech, and background noise speech.

10. The computer-implemented method of claim 1, wherein the operations further comprise, for each training sample of the plurality of training samples having a corresponding transcription that comprises only a whole transcript of all speech present in the corresponding audio data:
processing, using a primary teacher speech recognition model, the corresponding audio data to obtain a primary transcript of only speech spoken by a primary speaker in the corresponding audio data,
wherein re-labeling the corresponding training sample comprises re-labeling the corresponding training sample based on the primary transcript and the whole transcript.

11. The computer-implemented method of claim 10, wherein the primary teacher speech recognition model is trained on supervised data obtained from domains that require only a primary speaker transcript.

12. A system comprising:
data processing hardware; and
memory hardware in communication with the data processing hardware, the memory hardware storing instructions that when executed on the data processing hardware cause the data processing hardware to perform operations comprising:
receiving a plurality of training samples spanning multiple different domains, each corresponding training sample comprising audio data characterizing an utterance paired with a corresponding transcription of the utterance;
re-labeling each corresponding training sample of the plurality of training samples by annotating the corresponding transcription of the utterance with one or more speaker tags, each speaker tag indicating a respective segment of the transcription for speech that was spoken by a particular type of speaker; and
training a multi-domain speech recognition model on the re-labeled training samples to teach the multi-domain speech recognition model to learn to share parameters for recognizing speech across each of the multiple different domains.

13. The system of claim 12, wherein the multiple different domains comprise:
a short-form query domain; and
a dictation domain.

14. The system of claim 13, wherein the multiple different domains further comprise a captions domain.

15. The system of claim 12, wherein the corresponding transcription for each training sample comprises at least one of:
a whole transcript of all speech present in the corresponding audio data; or
a primary transcript of only speech spoken by a primary speaker in the corresponding audio data.

16. The system of claim 15, wherein re-labeling each corresponding training sample of the plurality of training samples comprises:
performing a sub-sequence match between the whole transcript and the primary transcript to identify one or more speaker tag boundaries; and
annotating the whole transcript with the one or more speaker tags based on the one or more speaker tag boundaries identified by performing the sub-sequence match between the whole transcript and the primary transcript.

17. The system of claim 12, wherein the particular type of speaker indicated by each speaker tag comprises a primary speaker or a non-primary speaker.

18. The system of claim 17, wherein:
speech spoken by the primary speaker corresponds to speech directed toward a target application; and
speech spoken by the non-primary speaker comprises at least one of:
background speech spoken by a speaker other than the primary speaker;
recorded or broadcasted speech emanating from an audio output device; or
synthesized speech.

19. The system of claim 12, wherein the operations further comprise, for each training sample of the plurality of training samples having a corresponding transcription that comprises only a primary transcript of speech spoken by a primary speaker in the corresponding audio data and omits transcripts of any other speech in the corresponding audio data not spoken by the primary speaker:
processing, using a general teacher speech recognition model, the corresponding audio data to obtain a whole transcript of all speech present in the corresponding audio data,
wherein re-labeling the corresponding training sample comprises re-labeling the corresponding training sample based on the primary transcript and the whole transcript.

20. The system of claim 19, wherein the general teacher speech recognition model is trained on a training data set to teach the general teacher speech recognition model to recognize primary speech, secondary speech, and background noise speech.

21. The system of claim 12, wherein the operations further comprise, for each training sample of the plurality of training samples having a corresponding transcription that comprises only a whole transcript of all speech present in the corresponding audio data:
processing, using a primary teacher speech recognition model, the corresponding audio data to obtain a primary transcript of only speech spoken by a primary speaker in the corresponding audio data,
wherein re-labeling the corresponding training sample comprises re-labeling the corresponding training sample based on the primary transcript and the whole transcript.

22. The system of claim 21, wherein the primary teacher speech recognition model is trained on supervised data obtained from domains that require only a primary speaker transcript.
